(19) United States
(12) Patent Application Publication
(10) Pub. No.: US 2026/0077564 A1
(43) Pub. Date: Mar. 19, 2026

(54) METHOD OF PREPARING A BONDING SURFACE ON A COMPOSITE LAMINATE AND ASSOCIATED COMPOSITE LAMINATE

(71) Applicant: The Boeing Company, Arlington, VA (US)

(72) Inventors: Evan F. Pierce, Los Angeles, WA (US); Kevin Braun, Mill Creek, WA (US); Robert Griffith, Marysville, WA (US); John Osborne, Seattle, WA (US)

(21) Appl. No.: 18/890,267

(22) Filed: Sep. 19, 2024

(51) Int. Cl. B29C 70/30; B29K 307/04; B29K 309/08; B29L 31/30

(52) U.S. Cl. CPC B29C 70/302; B29K 2307/04; B29K 2309/08; B29K 2995/0097; B29L 2031/3085

(57) ABSTRACT

Disclosed herein is a method of preparing a bonding surface on a composite laminate and an associated composite laminate. The method involves forming a layup of multiple fiber-reinforced plies, including main body plies with a first combined thickness and peel plies with a second combined thickness. The method also includes selectively removing a portion of the main body plies along an edge to create an interim composite laminate with a lip defined by the peel plies. A force is applied to the lip to initiate a crack between the peel plies and the main body plies. The lip is then peeled away from the main body plies to remove the peel plies and expose a bonding surface on the composite laminate.

### FIELD

This disclosure relates generally to composite materials, and more particularly to bond surface preparation of composite materials.

### BACKGROUND

In the field of composite materials, the preparation of bonding surfaces helps to ensure strong and durable joints between bonded adherends. Commonly, peel plies are used in the fabrication of composite laminates to protect the bonding surface from contamination, ensure a consistent surface texture, and enhance adhesion by creating a clean, roughened surface ideal for a subsequent bonding operation. Once the fabrication process of a composite laminate is complete, the peel ply is removed to expose the prepared bonding surface, ready for adhesive application. Removal of the peel ply can be challenging as traditional peel plies often break into multiple pieces during removal, which makes the process time-consuming and difficult. Additionally, removal of a peel ply can leave behind residue or cause damage to the bonding surface, which may potentially compromise the quality of the bonding surface.

### SUMMARY

The subject matter of the present application has been developed in response to the present state of the art, and in particular, in response to the shortcomings of conventional peel ply removal, that have not yet been fully solved by currently available techniques. Accordingly, the subject matter of the present application has been developed to provide a method of preparing a bonding surface and associated composite laminate that overcome at least some of the above-mentioned shortcomings of prior art techniques.

The following is a non-exhaustive list of examples, which may or may not be claimed, of the subject matter, disclosed herein.

Disclosed herein is a method of preparing a bonding surface on a composite laminate. The method includes laying up multiple fiber-reinforced plies to form a layup. The layup includes main body plies, having a first combined thickness, and peel plies, having a second combined thickness. The method also includes selectively removing a portion of the main body plies along an edge portion of the layup to form an interim composite laminate and to create a lip defined by a portion of the peel plies having a thickness equal to the second combined thickness. The method further includes fixing the interim composite laminate relative to a support object so that the peel plies are facing the support object and the lip is overhanging an edge of the support object. The method additionally includes applying a force to the lip to initiate a crack between the peel plies and the main body plies within the interim composite laminate and peeling the lip away from the main body plies to remove the peel plies from the main body plies to form the composite laminate and expose the bonding surface on the composite laminate. The preceding subject matter of this paragraph characterizes example 1 of the present disclosure.

The main body plies are a first material. The peel plies are a second material. The first material is the same as the second material. The preceding subject matter of this paragraph characterizes example 2 of the present disclosure, wherein example 2 also includes the subject matter according to example 1, above.

The main body plies are a first material. The peel plies are a second material. The first material is different than the second material. The preceding subject matter of this paragraph characterizes example 3 of the present disclosure, wherein example 3 also includes the subject matter according to example 1, above.

The step of applying a force to the lip includes applying a force in a force direction that is parallel to the first combined thickness of the main body plies. The preceding subject matter of this paragraph characterizes example 4 of the present disclosure, wherein example 4 also includes the subject matter according to any of examples 1-3, above.

A junction between the lip and the main body plies defines a zero-radius corner. The preceding subject matter of this paragraph characterizes example 5 of the present disclosure, wherein example 5 also includes the subject matter according to any of examples 1-4, above.

The step of peeling the lip away from the main body plies includes manually peeling the lip away from the main body plies. The preceding subject matter of this paragraph characterizes example 6 of the present disclosure, wherein example 6 also includes the subject matter according to any of examples 1-5, above.

The method includes applying an adhesive to the bonding surface of the composite laminate and bonding the bonding surface of the composite laminate to a laminate-receiving surface of a bonding part. The preceding subject matter of this paragraph characterizes example 7 of the present disclosure, wherein example 7 also includes the subject matter according to any of examples 1-6, above.

The composite laminate is a laminate spacer configures to provide a predetermined spacing between a wing access door and a lower wing panel of an aircraft. The bonding part is the lower wing panel. The preceding subject matter of this paragraph characterizes example 8 of the present disclosure, wherein example 8 also includes the subject matter according to example 7, above.

Further disclosed herein an interim composite laminate. The interim composite laminate includes a full thickness portion including multiple fiber-reinforced plies arranged in a layup. The full thickness portion includes main body plies, having a first combined thickness, and peel plies, having a second combined thickness. The interim composite laminate also includes an edge portion defined by a portion of the peel plies, extending from the full thickness portion about a periphery of the full thickness portion, and defining a lip with a thickness equal to the second combined thickness of the peel plies. The lip is configured to facilitate the initiation of a crack between the peel plies and the main body plies of the full thickness portion upon application of a force to the lip 110. After the initiation of the crack, the peel plies of the full thickness portion are configured to be removed from the main body plies by peeling the lip away from the main body plies to form a composite laminate and expose a bonding surface on the composite laminate. The preceding subject matter of this paragraph characterizes example 9 of the present disclosure.

The main body plies are a first material. The peel plies are a second material. The first material is the same as the second material. The preceding subject matter of this paragraph characterizes example 10 of the present disclosure, wherein example 10 also includes the subject matter according to example 9, above.

The main body plies are a first material. The peel plies are a second material. The first material is different than the second material. The preceding subject matter of this paragraph characterizes example 11 of the present disclosure, wherein examples 11 also includes the subject matter according to example 9, above.

A junction between the lip and the main body plies defines a zero-radius corner. The preceding subject matter of this paragraph characterizes example 12 of the present disclosure, wherein example 12 also includes the subject matter according to any of examples 9-11, above.

The second combined thickness of the peel plies is equal to or greater than 0.018 inches. The preceding subject matter of this paragraph characterizes example 13 of the present disclosure, wherein example 13 also includes the subject matter according to any of examples 9-12, above.

The multiple fiber-reinforced plies are made of a fiberglass-reinforced polymer. The preceding subject matter of this paragraph characterizes example 14 of the present disclosure, wherein example 14 also includes the subject matter according to any of examples 9-13, above.

The multiple fiber-reinforced plies are made of a carbon fiber-reinforced polymer. The preceding subject matter of this paragraph characterizes example 15 of the present disclosure, wherein example 15 also includes the subject matter according to any of examples 9-13, above.

The edge portion extends from the full thickness portion about an entirety of the perimeter of the full thickness portion. The preceding subject matter of this paragraph characterizes example 16 of the present disclosure, wherein example 16 also includes the subject matter according to any of examples 9-15, above.

The edge portion extends from the full thickness portion about a section of the perimeter of the full thickness portion. The preceding subject matter of this paragraph characterizes example 17 of the present disclosure, wherein example 17 also includes the subject matter according to any of examples 9-15, above.

The first combined thickness of the main body plies is greater than the second combined thickness of the peel plies. The preceding subject matter of this paragraph characterizes example 18 of the present disclosure, wherein example 18 also includes the subject matter according to any of examples 9-17, above.

The composite laminate is a laminate spacer configured to be utilized on a lower wing panel of an aircraft. The preceding subject matter of this paragraph characterizes example 19 of the present disclosure, wherein example 19 also includes the subject matter according to any of examples 9-18, above.

Further disclosed herein is a method for forming a laminate spacer. The method includes laying up multiple fiber-reinforced plies to form a layup. The layup includes main body plies, having a first combined thickness, and peel plies, having a second combined thickness. The method also includes selectively removing a portion of the main body plies along an edge portion of the layup to form an interim composite laminate and to create a lip defined by a portion of the peel plies having a thickness equal to the second combined thickness. The method further includes fixing the interim composite laminate relative to a support object so that the peel plies are facing the support object and the lip is overhanging an edge of the support object. The method additionally includes applying a force to the lip to initiate a crack between the peel plies and the main body plies within the interim composite laminate and peeling the lip away from the main body plies to remove the peel plies from the main body plies to form the laminate spacer and expose the bonding surface on the laminate spacer. The method also includes applying an adhesive to the bonding surface of the laminate spacer and bonding the bonding surface of the laminate spacer to a laminate-receiving surface of a lower wing panel of an aircraft. The laminate spacer is configured to provide a predetermined spacing between a wing access door and the lower wing panel. The preceding subject matter of this paragraph characterizes example 20 of the present disclosure.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1A is a schematic perspective exploded view of multiple fiber-reinforced plies of a layup, according to one or more examples of the present disclosure;

FIG. 1B is a schematic perspective view of the layup of the multiple fiber-reinforced plies of FIG. 1A, according to one or more examples of the present disclosure;

FIG. 1C is a schematic cross-sectional view of the layup of FIG. 1B, taken along the plane 1-1 of FIG. 1B, according to one or more examples of the present disclosure;

FIG. 2A is a schematic side view of an interim composite laminate, having main body plies and peel plies, according to one or more examples of the present disclosure;

FIG. 2B is a schematic side view of the interim composite laminate of FIG. 2A, with a crack initiated between the main body plies and the peel plies, according to one or more examples of the present disclosure;

FIG. 3A is a schematic side view of the interim composite laminate of FIG. 2A, with the peel plies being removed from the main body plies, according to one or more examples of the present disclosure;

FIG. 3B is a schematic perspective view of composite laminate formed by removing the peel plies from the main body plies of the interim composite laminate, according to one or more examples of the present disclosure;

FIG. 4A is a schematic perspective view of one example of an interim composite laminate, according to one or more examples of the present disclosure;

FIG. 4B is a schematic cross-sectional view of the interim composite laminate of FIG. 4A, taken along the plane 4-4 of FIG. 4A, according to one or more examples of the present disclosure;

FIG. 5A is a schematic perspective view of another example of an interim composite laminate, according to one or more examples of the present disclosure;

FIG. 5B is a schematic cross-sectional view of the interim composite laminate of FIG. 5A, taken along the plane 5-5 of FIG. 5A, according to one or more examples of the present disclosure;

FIG. 6 is a schematic, cross-sectional, partial view of one example of an edge portion of an interim composite laminate, according to one or more examples of the present disclosure;

FIG. 7A is a schematic top view of one example of a composite laminate, having an exposed bonding surface, according to one or more examples of the present disclosure;

FIG. 7B is a schematic top view of the composite laminate of FIG. 7A with an adhesive added to the bonding surface, according to one or more examples of the present disclosure;

FIG. 7C is a schematic side view of the composite laminate of FIG. 7B bonded to a bonding part, according to one or more examples of the present disclosure;

FIG. 8 is a schematic flow chart of a method of preparing a bonding surface on a composite laminate, according to one or more examples of the present disclosure; and

FIG. 9 is a schematic flow chart of a method of forming a laminate spacer, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

In order to prepare a bonding surface on a composite laminate, a peel ply—a sacrificial layer—is commonly applied, which must be removed before bonding. Traditional peel plies are non-structural, made from materials such as a woven nylon or polyester fabric, and serve solely as a sacrificial layer. Conventional peel ply removal methods often require the use of a pointed tool to force between the peel ply and the underlying laminate at an edge of the composite, which can result in direct contact of the tool with the bonding surface. Conventional peel ply removal methods can be imprecise, which may lead to uneven crack propagation, partial peel ply removal, or unintended damage to the underlying bonding surface. Additionally, the removal process can introduce contaminants to the bonding surface if not properly controlled, which may further compromise the integrity of the bond.

Disclosed herein is a method of preparing a bonding surface on a composite laminate and the associated composite laminate that eliminates the need for an external object to be forced between the peel ply and the underlying composite laminate. The method of the present disclosure involves selectively removing a portion of the composite laminate along an edge to create a lip that extends from the bulk of the composite laminate. The lip is characterized by a thickness equal to the combined thickness of the peel plies and is used to initiate a crack (e.g., disbond) during the peel ply removal process. Specifically, a force is applied to the lip to initiate the crack between the peel plies and the underlying composite laminate, avoiding the need to insert a tool directly between the two layers. Thereafter, the lip is utilized to remove the peel plies and expose a bonding surface of the composite laminate. Additionally, unlike traditional non-structural materials used for peel plies, the peel ply in this method is a structural laminate, providing additional strength and rigidity to the composite laminate during the manufacturing process. The structural nature of the peel ply ensures it can withstand the forces applied during the removal process while maintaining the integrity of the bonding surface.

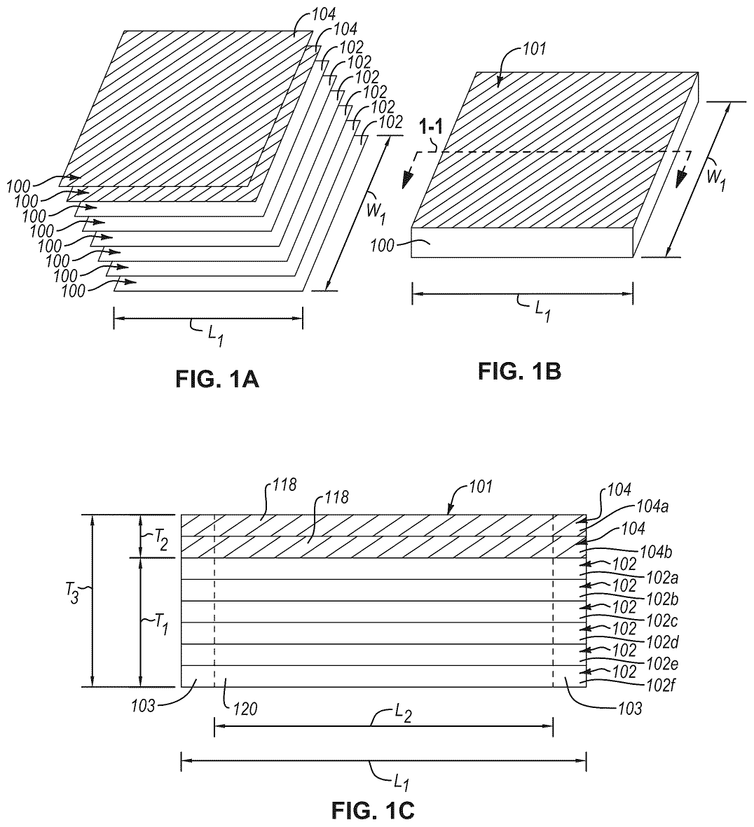

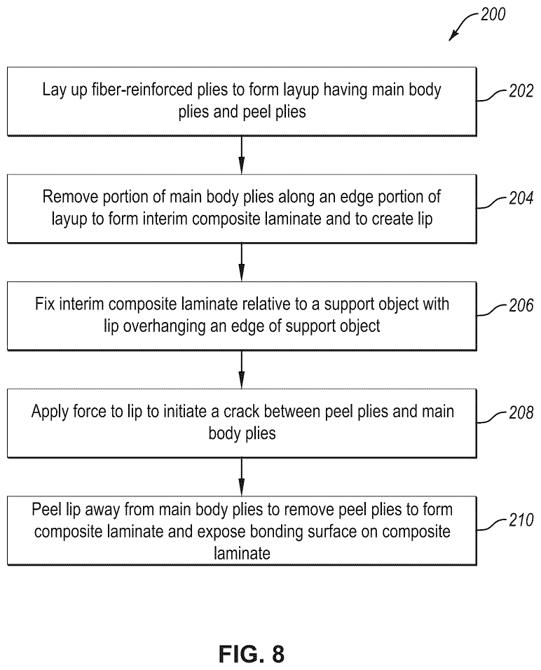

According to some examples, a method 200 of preparing a bonding surface on a composite laminate is shown in FIG. 8. Referring generally to FIG. 8 and specifically to FIGS. 1A-1C, the method 200 includes (block 202) laying up multiple fiber-reinforced plies 100, each of which is a structural laminate, to form a layup 101 having main body plies 102, with a first combined thickness (T₁), and peel plies 104, with a second combined thickness (T₂). As shown in exploded view in FIG. 1A, the multiple fiber-reinforced plies 100 are arranged in a stacked configuration, where a first portion of the multiple fiber-reinforced plies 100 are main body plies 102, and a second portion forms the peel plies 104. In some examples, each one of the multiple fiber-reinforced plies 100 has common dimensions, such as a common width (W₁) and a common length (L₁). Moreover, the multiple fiber-reinforced plies 100, although depicted in a square shape in the figures, can be formed in various shapes and sizes depending on the specific application requirements. These shapes may include but are not limited to, rectangular, circular, or irregular geometries, allowing for customization to suit the design specifications of the final composite laminate.

As shown in FIGS. 1B and 1C, a layup 101 is formed by stacking the multiple fiber-reinforced plies 100. The main body plies 102 are structural plies that provide structural integrity to the final composite laminate. Each one of the main body plies 102 is arranged atop the others, layer by layer, to achieve a desired first combined thickness (T₁), forming the primary section of the layup 101. In some examples, each one of the main body plies 102 is substantially identical having a common material, common length, common width, and common thickness. In other examples, at least one of the main body plies 102 may be different from others in one or more of these characteristics. The layup 101 may include any number of plies within the main body plies 102 depending on the desired combined first thickness (T₁), which ultimately defines the thickness of the final composite laminate. As shown, the main body plies 102 include six plies: a first main body ply 102a, a second main body ply 102b, a third main body ply 102c, a fourth main body ply 102d, a fifth main body ply 102e, and an nth main body ply 102n. The six plies 102a-102n are shown for representative purposes, as the main body plies 102 may include more or fewer than those illustrated. In some examples, the main body plies 102 may include, between and inclusive of 5 to 100 plies, in other examples, between and inclusive of 10 to 50 plies, and in yet other examples, 15 to 40 plies. Moreover, the combined first thickness (T₁) of the main body plies 102 is, in some examples, between and inclusive of 0.15 inches to 1 inch, in other examples, between and inclusive of 0.17 and 0.5 inches, and in yet other examples, between and inclusive of 0.18 and 0.2 inches.

The peel plies 104 are positioned relative to the main body plies 102 and collectively serve as a sacrificial layer that will be removed from the main body plies 102. As used herein, peel plies refer to a group of structural plies that, in addition to serving as a sacrificial layer to protect the bonding surface, also contribute to the structural integrity of the composite laminate during the manufacturing process. Unlike traditional non-structural peel plies, the peel plies 104 are designed to withstand machining or other composite removal processes and applied forces, providing both protective and supportive functions within the layup 101. Each one of the peel plies 104 is arranged atop the other, layer by layer, to achieve a desired second combined thickness (T₂). In some examples, each one of the peel plies 104 is substantially identical having a common material, common width, common length, and common thickness. In other examples, at least one of the peel plies 104 may be different from others in one or more of these characteristics. The layup 101 may include any number of plies within the peel plies 104 depending on the desired combined second thickness (T₂). As shown, the peel plies 104 include two plies: a first peel ply 104a and a second peel ply 104b. The two peel plies 104a-104b are shown for representative purposes, as the peel plies 104b may include more or fewer than those illustrated.

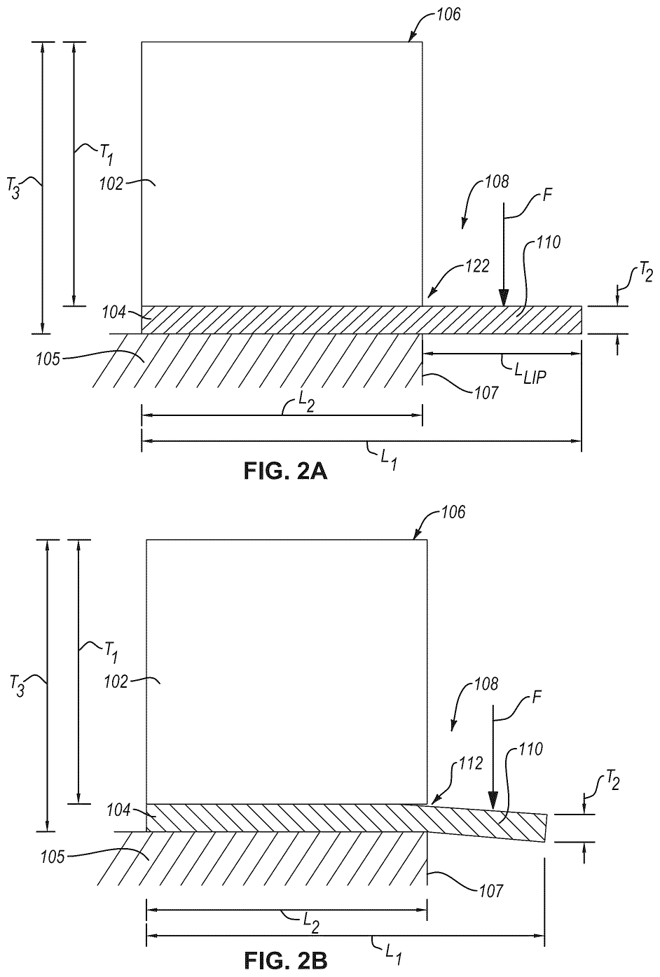

At least a portion of one of the common width (W₁) or the common length (L₁) of the multiple fiber-reinforced plies 100 includes an intentional amount of excess material 103, providing additional material that extends beyond the final dimensions of the composite laminate (e.g., beyond the footprint or outer perimeter of the main body plies 102 forming the composite laminate). This excess material 103 allows for material to be selectively removed from a portion of the main body plies 102 during the removal process to achieve the desired final dimensions, as well as, create a lip from the peel plies 104 (see, e.g., FIG. 2A). That is, excess material 103 is included in at least a portion of the common width (W₁) or the common length (L₁) of the multiple fiber-reinforced plies 100 to account for the material that is later removed from the main body plies 102. As shown in FIG. 1C, the common length (L₁) of the main body plies 102 includes a length (L₂) of the main body plies (i.e., the final length of composite laminate) plus any excess material 103.

The first combined thickness (T₁) of the main body plies 102 is greater than the second combined thickness (T₂) of the peel plies 104. The first combined thickness (T₁) of the main body plies 102 is designed to provide the primary structural integrity of the final composite laminate, ensuring sufficient strength and rigidity.

Conversely, the thinner thickness of the peel plies 104, while still contributing structurally to the layup 101 during processing, is designed to be easily removed from the main body plies 102. For example, in some cases, the second combined thickness (T₂) is equal to or greater than 0.018 inches. In some examples, the ratio between the first combined thickness (T₁) to the second combined thickness (T₂) is between and inclusive of 5:1 to 20:1. In other examples, the ratio is between and inclusive of 8:1 to 15:1. In yet other examples, the ratio is between and inclusive of 9:1 to 10:1. The total thickness (T₃) of the layup 101 is the sum of the first combined thickness (T₁) and the second combined thickness (T₂).

The main body plies 102 are made of a first material 118. The peel plies 104 are made of a second material 120. Both the first material and the second material are a fiber-reinforced polymeric material that provides strength, stiffness, and durability to the layup 101. For example, the fiber-reinforced material may be a fiberglass-reinforced polymer, carbon fiber-reinforced polymer, or aramid fiber-reinforced polymer. In some examples, the first material 118 is the same as the second material 120. For example, the layup 101 may be made of substantially identical fiber-reinforced plies 100, with a specific number of plies functioning as the peel plies 104, or plies that are configured for removal. In other examples, the first material 118 is different than the second material 120.

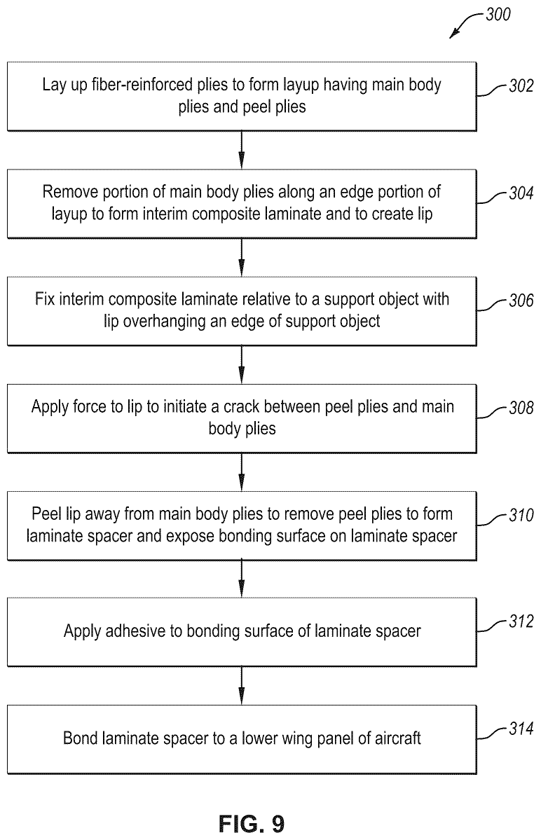

Referring generally to FIG. 9 and specifically to FIG. 2A, the method 200 also includes (block 204) selectively removing a portion of the main body plies 102 along an edge portion 108 of the layup 101 to form an interim composite laminate 106 and to create a lip 110 defined by a portion of the peel plies 104. The lip 110 has a thickness equal to the second combined thickness (T₂). That is, the excess material 103 of the main body plies 102 of the layup 101 is removed and the excess material 103 of the peel plies 102, which is not removed, forms the lip 110. As used herein, the interim composite laminate 106 refers to the intermediate stage of the manufacturing of the composite laminate, after the excess material 103 is removed from the main body plies 102.

The excess material 103 is selectively removed from the main body plies 102 using any suitable removal process. The removal process may include but is not limited to, machining, which involves precisely cutting or grinding the excess material 103, or chemical etching, where a chemical solution is used to dissolve the excess material 103. Other removal processes such as laser cutting, abrasive water jet cutting, or sanding may also be utilized. This selective removal is performed on the main body plies 102, while leaving the peel plies 104 intact, so that the peel plies 104 extend beyond the length (L₂) of the main body plies 102 to form the lip 110. Accordingly, a junction 122 is formed between the lip 110 and the main body plies 102, after removal of the excess material 103. The junction 122 defines a zero-radius corner, which is characterized by a sharp interface between a lateral surface of the main body plies 102, and the lip 110. The zero-radius corner creates a stress concentration point at the junction 122 during a force application to the lip 110.

The lip 110 has a lip length (L_{Lip}) that extends beyond the length (L₂) of the main body plies 102. That is, the lip length (L_{Lip}) together with the length (L₂) of the main body plies 102 is the common length (L₁). The lip length (L_{Lip}) is configured to be of sufficient length to receive a force (F) and to provide a secure grip on the lip 110 during the removal of the peel plies 104 from the main body plies 102. In some examples, the lip length (L_{Lip}) is between and inclusive of 0.1 inches and 1 inch, in other examples, between and inclusive of 0.2 inches and 0.5 inches, and in yet other examples, between and inclusive of 0.25 inches and 0.4 inches.

The method 200 also includes (block 206) fixing the interim composite laminate 106 relative to a support object 105 so that the peel plies 104 are facing the support object 105 and the lip 110 is overhanging an edge 107 of the support object 105. The support object 105 is a stable, rigid structure designed to support the interim composite laminate 106 during a force application, which ensures that the bulk of the interim composite laminate 106 remains stationary and supported. This configuration allows the lip 110 to overhang freely, enabling movement (e.g. bending or flexing) of the lip 110 when the force (F) is applied to the lip 110. Accordingly, the support object 105 facilitates the force application, allowing the lip 110 to be moved as needed, without compromising the integrity of the main body plies 102.

Referring back generally to FIG. 9, and specifically to FIG. 2B, the method 200 further includes (block 208) applying the force (F) to the lip 110 to initiate a crack 112 between the peel plies 104 and the main body plies 102 within the interim composite laminate 106. The force (F) is directed in a manner that leverages the overhang in the lip 110, causing a stress concentration at the junction 122 where the peel plies 104 met the main body plies 102. This stress concentration facilitates the initiation of the crack 112 between the peel plies 104 and the main body plies 102. That is, the crack 112 propagates along the interface between the peel plies 104 and the main body plies 102 effectively separating the peel plies 104 from the main body plies 102 at the junction 122, without contacting the bonding surface.

In some examples, the force (F) is applied in a force direction that is parallel to the first combined thickness (T₁) of the main body plies 102. The differing thicknesses of the first combined thickness (T₁) and the second combined thickness (T₂) ensures that the crack 112 propagates along the interface between the peel plies 104 and the main body plies 102. That is, the second combined thickness (T₂) is selected so that the peel plies 104 are strong enough to initiate the crack 112, yet thin enough to facilitate the separation of the peel plies 104 from the main body plies 102 without causing damage or propagating the crack 112 through the main body plies 102.

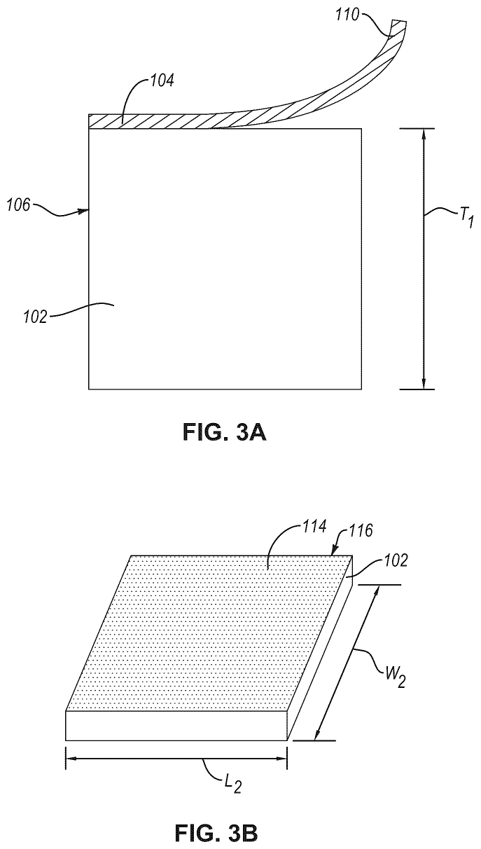

Referring generally to FIG. 9, and specifically to FIG. 3A, the method 200 further includes (block 210) peeling the lip 110 away from the main body plies 102 to remove the peel plies 104 from the main body plies 102 to form a composite laminate 116 and expose a bonding surface 114 on the composite laminate 116. This action separates the peel plies 104 from the main body plies 102, which results in the removal of the peel plies 104. The interim composite laminate 106 may be removed from the support object 105 during the removal process. In some examples, the peel plies 104 are manually peeled away from the main body plies 102 by gripping the lip 110. In other examples, the peeling process may be automated removed using a machine designed to apply a force or grip to the lip 110 to remove the plies. Regardless of the method used, the peeling process involves pulling the peel plies 104 away from the bonding surface 114. The peel plies 104 are sufficiently flexible, allowing them to bend and conform to the forces applied during the peeling process. This flexibility ensures that the peel plies 104 can be effectively separated from the main body plies 102 without damaging the exposed bonding surface 114.

Once the peel plies 104 are removed, the bonding surface 114 of the composite laminate 116 is exposed, as shown in FIG. 3B. The bonding surface 114 is prepared for subsequent bonding processes, requiring minimal to no additional surface preparation. In some examples, the bonding surface 114, exposed after the removal of the peel plies 104, has a textured finish that is useful in adhesive bonding. The textured finish may be inherently created by the removal of the peel plies 104, helping enhance the mechanical interlocking of adhesives during subsequent bonding operations. In some examples, the removal of the peel plies 104 leaves the bonding surface with many broken epoxy bonds, creating a high-energy surface that is receptive to forming strong adhesive bonds.

The composite laminate 116 has a thickness corresponding to the first combined thickness (T₁) of the main body plies 102, as the composite laminate 116 is comprised solely of the main body plies 102. Additionally, the composite laminate 116 has a length (L₂) and a width (W₂). In examples where the excess material 103 was selectively removed from an entire perimeter of the layup 101, the length (L₂) and width (W₂) of the composite laminate 116 will be smaller than the common length (L₁) and the common width (W₁), respectively, of the layup 101. Alternatively, in examples where the excess material 103 is selectively removed from a portion of the at least one of the common length (L₁) and the common width (W₁) of the layup 101, the composite laminate 116 will have a length (L₂) and/or a width (W₂) that is reduced corresponding to any areas where the excess material 103 was removed. Accordingly, as a result of the selective removal process, the shape and size of the composite laminate 116 differs from the layup 101. The composite laminate 116 typically retains the overall shape of the layup 101 but with reduced dimensions compared to the original dimensions.

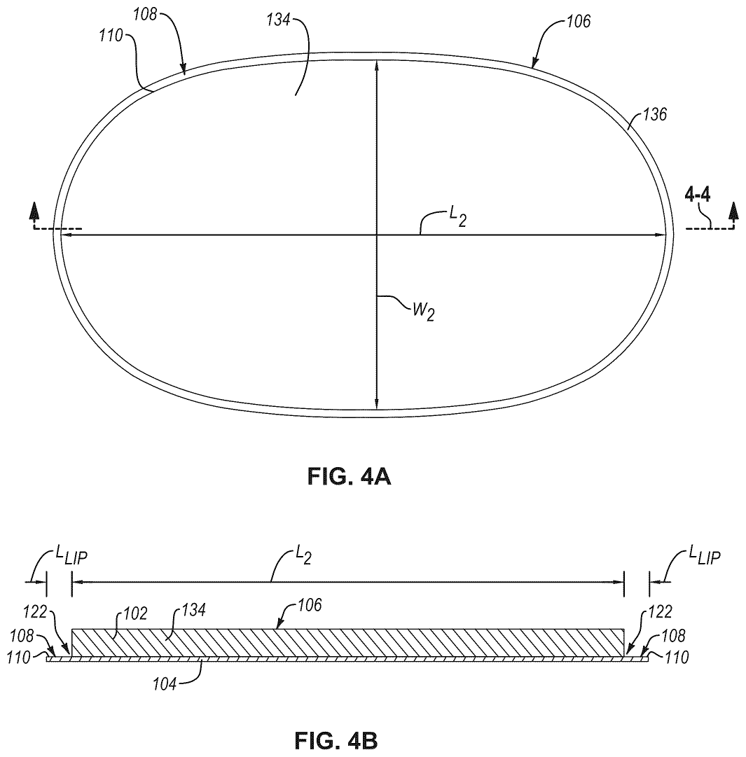

Referring to FIGS. 4A and 4B, one example of an interim composite laminate 106 is shown. The interim composite laminate 106 includes a full thickness portion 134 and an edge portion 108 extending from the full thickness portion 134 about a periphery 136 of the full thickness portion 134. The periphery 136 outlines the boundary between the full thickness portion 134 and the edge portion 108, where the lip 110 is extended. The full thickness portion 134 includes the multiple fiber-reinforced plies 100 with main body plies 102, having a first combined thickness (T₁) and peel plies 104, having a second combined thickness (T₂). As shown, the edge portion 108 surrounds an entirety of the periphery 136 of the full thickness portion 134. That is, the excess material 103 is selectively removed from the main body plies 102, creating the lip 110, that extends around the entirety of the periphery 136.

The lip 110 is utilized to initiate the separation of the peel plies 104 from the main body plies 102, as described above. Because the lip 110 extends around the entirety of the periphery 136, the crack can be propagated at the junction 122 from any point along the full thickness portion 134. The lip length (Lₗᵢₚ) is sufficient to receive the force (F) to propagate the crack and also provide a secure grip during the separation of the peel plies 104 in the full thickness portion 134. After removal of the peel plies 104, the length (L₂) and the width (W₂) of the full thickness portion 134 represent the final dimensions of the composite laminate 116, which are now devoid of any excess material 103, reflecting the intended final shape and size of the composite laminate.

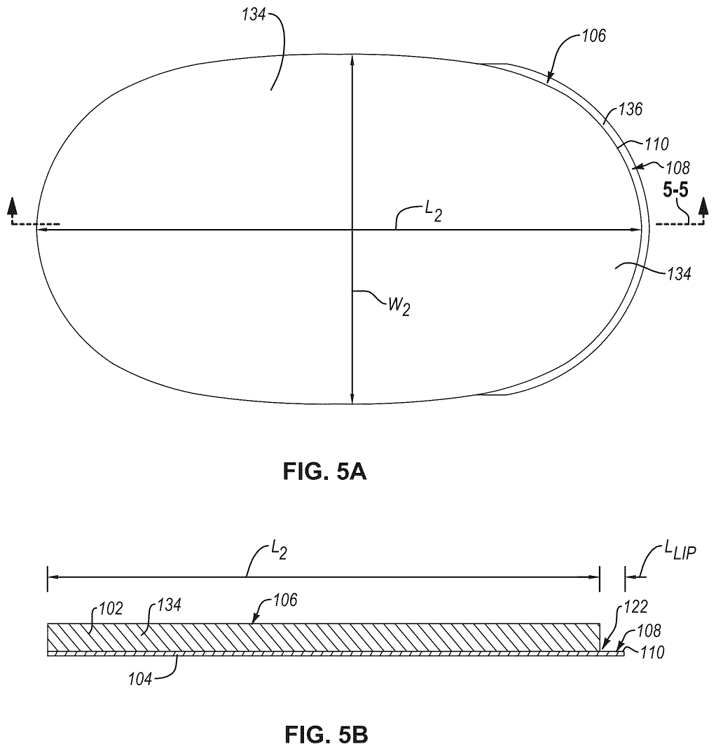

Referring to FIGS. 5A and 5B is another example of an interim composite laminate 106. Unlike the configuration depicted in FIGS. 4A and 4B, where the edge portion 108 surrounds the entirety of the periphery 136 of the full thickness portion 134, in this example, the edge portion 108 extends only along a portion of the periphery 136. Specifically, the lip 110 is formed only in a select region of the interim composite laminate 106, rather than continuously around the perimeter.

The full thickness portion 134 includes the multiple fiber-reinforced plies 100 with main body plies 102, having the first combined thickness (T1, and peel plies 104, having the second combined thickness (T₂). However, the selective removal of excess material 103 from the main body plies 102 is localized, resulting in the formation of the lip 110 only in specific areas where the removal process was applied. The remaining areas of the full thickness portion 134 maintain the original dimensions of the layup 101 without forming a lip 110. The lip 110 functions to initiate the separation of the peel plies 104 from the main body plies 102 as described previously. However, the crack propagation and subsequent removal of the peel plies 104 are initiated only in the regions where the lip 110 is present. The length (L₂) and the width (W₂) of the full thickness portion 134 define the final dimensions of the composite laminate 116, with regions of the periphery 136 remaining unchanged.

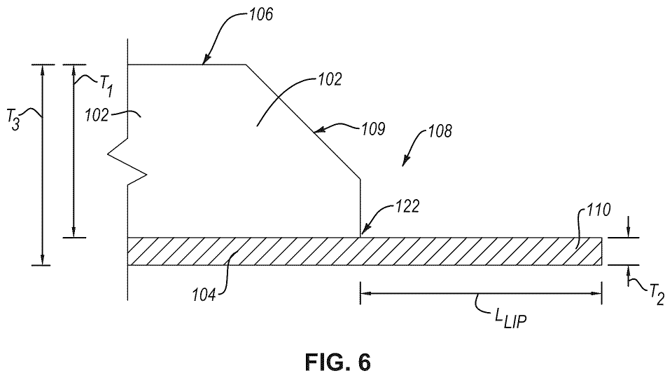

In some examples, the edge portion 108 may be a linear lateral surface where excess material 103 is removed to form the lip 110. In other examples, as shown in FIG. 6, the edge portion 108 of the interim composite laminate 106 may include additional cutouts or variations in geometry that provide a customized shape to suit the specific application needs of the composite laminate 116. That is, in addition to removing the excess material 103 to form the lip 110, a corner relief 109 may be formed by removing a portion of the main body plies 102 at a top edge, opposite of the junction 122, of the full thickness portion 134. The corner relief 109 is a cut or notch that creates an angled, stepped, or otherwise non-linear surface along the lateral surface of the main body plies 102. The purpose of the corner relief 109 may be to accommodate specific geometric requirements for subsequent bonding applications, where a precise final shape is necessary to fit the composite laminate 116 into an assembly or to ensure proper alignment with adjoining components. Additionally, or alternatively, the corner relief 109 may also help minimize stress concentrations along the lateral surface of the main body plies 102 during the subsequent bonding processes.

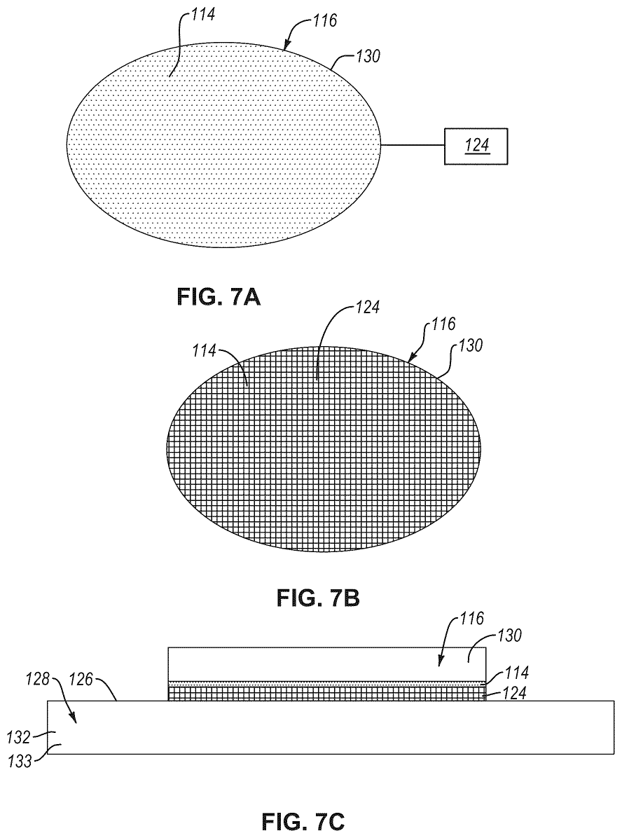

As shown in FIGS. 7A-7C, after the composite laminate 116 is formed using the method 200, or method 300, described below, the bonding surface 114 is prepared for subsequent bonding applications. Referring to FIG. 7A, an adhesive 124 is configured to be applied to the bonding surface 114 of the composite laminate 116, such that the composite laminate 116 may be bonded to another component (i.e., bonding part). Before the adhesive 124 is applied, the bonding surface 114 should be free of contaminants and defects to ensure optimal adhesion. The adhesive 124 is selected based on its compatibility with the composite laminate material and its ability to provide strong, durable bonds under the expected operational conditions. Referring to FIG. 7B, the adhesive 124 is applied to the bonding surface 114. The adhesive 124 may be applied to the bonding surface 114 using any of various methods, including brushing, spraying, or spreading the adhesive 124 on the bonding surface 114. Alternatively, the bonding surface 114 may be placed directly onto an adhesive layer, and manually compacted to remove any voids or air pockets between the bonding surface 114 and the adhesive layer. Generally, the adhesive 124 is evenly distributed across the bonding surface 114 for complete coverage to facilitate a strong, uniform bond when the composite laminate 116 is joined with the bonding part 128. FIG. 7C illustrates a side cross-sectional view of the composite laminate 116 during the bonding process. The adhesive 124 has been applied to the bonding surface 114, and the composite laminate 116 is positioned on a laminate-receiving surface 126 of the bonding part 128. The bonding part 128 is part of an assembly where the composite laminate 116 is being secured.

In some examples, the composite laminate 116 is a laminate spacer 130 that is configured to be utilized as a structural component designed to maintain a specified gap or distance (i.e., predetermined spacing) between two adjacent parts within an assembly. The main body plies 102 of the laminate spacer 130 provide the necessary thickness, strength, and stiffness to ensure that the spacing remains consistent under the load and stress of the assembly. In some examples, the laminate spacer 130 is utilized to maintain the spacing between a lower wing panel 132 of an aircraft 133 and a wing access door. That is, the laminate spacer 130 is bonded to a predetermined location along the lower wing panel 132 to ensure the predetermined spacing is maintained between the predetermined location and a corresponding wing access door location. In some examples, multiple laminate spacers 130 are bonded to the lower wing panel 132, each aligning with a specific predetermined location on the lower wing panel.

As shown in FIG. 9, a method 300 of forming a laminate spacer 130 is disclosed. The method 300 includes block 302, block 304, block 306, block 308, and block 310, which generally correspond to the previously described steps in method 200, specifically, block 202, block 204, block 206, block 208, and block 210, respectively. In method 300, the composite laminate 116 is specifically referred to as a laminate spacer 130, emphasizing its function of providing a predetermined spacing between two components.

The method 300 also includes (block 312) applying an adhesive 124 to the bonding surface 114 of the laminate spacer 130. The adhesive 124 may be evenly applied to the laminate spacer 130 using any of various methods. Additionally, the method 300 includes (block 314) bonding the bonding surface 114 of the laminate spacer 130 to a laminate-receiving surface 126 of a lower wing panel 132 of an aircraft 133.

The bonding process may involve applying pressure to ensure proper adhesion and alignment, and may also include curing the adhesive to achieve optimal bonding strength. The laminate spacer is configured to provide a predetermined spacing between a wing access door and the lower wing panel 132.

In the above description, certain terms may be used such as “up,” “down,” “upper,”“lower,”“horizontal,”“vertical,”“left,”“right,”“over,”“under”and the like. These terms are used, where applicable, to provide some clarity of description when dealing with relative relationships. But, these terms are not intended to imply absolute relationships, positions, and/or orientations. For example, with respect to an object, an “upper”surface can become a “lower”surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

The term “about” or “substantially” in some embodiments, is defined to mean within +/−5% of a given value, however in additional embodiments any disclosure of “about” may be further narrowed and claimed to mean within +/−4% of a given value, within +/−3% of a given value, within +/−2% of a given value, within +/−1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third”or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to”and/or as being “operative to”perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A method for preparing a bonding surface on a composite laminate, the method comprising:
laying up multiple fiber-reinforced plies to form a layup, wherein the layup comprises main body plies, having a first combined thickness, and peel plies, having a second combined thickness;
selectively removing a portion of the main body plies along an edge portion of the layup to form an interim composite laminate and to create a lip defined by a portion of the peel plies having a thickness equal to the second combined thickness;
fixing the interim composite laminate relative to a support object so that the peel plies are facing the support object and the lip is overhanging an edge of the support object;
applying a force to the lip to initiate a crack between the peel plies and the main body plies within the interim composite laminate; and
peeling the lip away from the main body plies to remove the peel plies from the main body plies to form the composite laminate and expose the bonding surface on the composite laminate.

2. The method of claim 1, wherein:
the main body plies comprise a first material;
the peel plies comprise a second material; and
the first material is the same as the second material.

3. The method of claim 1, wherein:
the main body plies comprise a first material;
the peel plies comprise a second material; and
the first material is different than the second material.

4. The method of claim 1, wherein the step of applying a force to the lip comprises applying the force in a force direction that is parallel to the first combined thickness of the main body plies.

5. The method of claim 1, wherein a junction between the lip and the main body plies defines a zero-radius corner.

6. The method of claim 1, wherein the step of peeling the lip away from the main body plies comprises manually peeling the lip away from the main body plies.

7. The method of claim 1, further comprising:
applying an adhesive to the bonding surface of the composite laminate; and
bonding the bonding surface of the composite laminate to a laminate-receiving surface of a bonding part.

8. The method of claim 7, wherein:
the composite laminate is a laminate spacer configured to provide a predetermined spacing between a wing access door and a lower wing panel of an aircraft; and
the bonding part is the lower wing panel.

9. An interim composite laminate comprising:
a full thickness portion comprising multiple fiber-reinforced plies arranged in a layup, the full thickness portion comprising main body plies, having a first combined thickness, and peel plies, having a second combined thickness; and
an edge portion defined by a portion of the peel plies, extending from the full thickness portion about a periphery of the full thickness portion, and defining a lip with a thickness equal to the second combined thickness of the peel plies;
wherein:
the lip is configured to facilitate initiation of a crack between the peel plies and the main body plies of the full thickness portion upon application of a force to the lip; and
after initiation of the crack, the peel plies of the full thickness portion are configured to be removed from the main body plies by peeling the lip away from the main body plies to form a composite laminate and expose a bonding surface on the composite laminate.

10. The interim composite laminate of claim 9, wherein:
the main body plies comprise a first material;
the peel plies comprise a second material; and
the first material is the same as the second material.

11. The interim composite laminate of claim 9, wherein:
the main body plies comprise a first material;
the peel plies comprise a second material; and
the first material is different than the second material.

12. The interim composite laminate of claim 9, wherein a junction between the lip and the main body plies defines a zero-radius corner.

13. The interim composite laminate of claim 9, wherein the second combined thickness of the peel plies is equal to or greater than 0.018 inches.

14. The interim composite laminate of claim 9, wherein the multiple fiber-reinforced plies are made of a fiberglass-reinforced polymer.

15. The interim composite laminate of claim 9, wherein the multiple fiber-reinforced plies are made of a carbon fiber-reinforced polymer.

16. The interim composite laminate of claim 9, wherein the edge portion extends from the full thickness portion about an entirety of the periphery of the full thickness portion.

17. The interim composite laminate of claim 9, wherein the edge portion extends from the full thickness portion about a section of the periphery of the full thickness portion.

18. The interim composite laminate of claim 9, wherein the first combined thickness of the main body plies is greater than the second combined thickness of the peel plies.

19. The interim composite laminate of claim 9, wherein the composite laminate is a laminate spacer configured to be utilized on a lower wing panel of an aircraft.

20. A method for forming a laminate spacer, the method comprising:
laying up multiple fiber-reinforced plies to form a layup wherein the layup comprises main body plies, having a first combined thickness, and peel plies, having a second combined thickness;
selectively removing a portion of the main body plies along an edge portion of the layup to form an interim composite laminate and to create a lip defined by a portion of the peel plies having a thickness equal to the second combined thickness;
fixing the interim composite laminate relative to a support object so that the peel plies are facing the support object and the lip is overhanging an edge of the support object;
applying a force to the lip to initiate a crack between the peel plies and the main body plies within the interim composite laminate;
peeling the lip away from the main body plies to remove the peel plies from the main body plies to form the laminate spacer and expose a bonding surface on the laminate spacer;
applying an adhesive to the bonding surface of the laminate spacer; and
bonding the bonding surface of the laminate spacer to a laminate-receiving surface of a lower wing panel of an aircraft, wherein the laminate spacer is configured to provide a predetermined spacing between a wing access door and the lower wing panel.
